(19) United States
(12) Patent Application Publication
(10) Pub. No.: US 2016/0370591 A1
(43) Pub. Date: Dec. 22, 2016

(54) HEAD MOUNTED DISPLAY

(71) Applicant: FOVE, INC., San Mateo, CA (US)

(72) Inventors: Lochlainn Wilson, Tokyo (JP); Bakui Chou, Tokyo (JP); Keiichi Seko, Tokyo (JP)

(21) Appl. No.: 14/897,883

(22) PCT Filed: Dec. 27, 2014
(86) PCT No.: PCT/JP2014/084723

§ 371 Date: Dec. 11, 2015

(51) Int. Cl. G02B 27/01; G02B 26/08

(52) U.S. Cl. CPC G02B 27/0179; G02B 27/0172; G02B 26/0833; G02B 2027/0187; G02B 2027/0112

(57) ABSTRACT

In a head mounted display to be mounted on a head of a user when being used, a light source can radiate invisible light. A camera images invisible light radiated from the light source and reflected by an eye of the user. An image output unit outputs an image imaged by the camera to a line-of-sight detecting unit configured to detect a direction of a line of sight of the user. A housing accommodates the light source, the camera, and the image output unit.

### TECHNICAL FIELD

This disclosure relates to a head mounted display.

### BACKGROUND

The technology of radiating invisible light such as near infrared light to an eye of a user and analyzing an image of the eye of the user together with light reflected by the eye, to thereby detect a direction of a line of sight of the user is known. Reflecting information on the detected line of sight of the user in, for example, a monitor of a personal computer (PC), a video game console or the like and using the information as a pointing device is also becoming a reality.

A head mounted display is a video display device configured to present a three-dimensional video to a user wearing the head mounted display. A head mounted display is usually worn to cover the user's sight when being used. Therefore, the user wearing the head mounted display is separated from the vision of the outside world. When the head mounted display is used as a display device of a video of a movie, a game or the like, it is difficult for the user to visually recognize an input device such as a controller.

It is therefore convenient if a direction of a line of sight of a user wearing the head mounted display can be detected and used as an alternative to a pointing device. However, the eyesight of a user wearing the head mounted display is blocked by a housing of the head mounted display and, thus, it is difficult to radiate invisible light to an eye of the user from outside the head mounted display.

It could therefore be helpful to provide a technology of detecting a direction of a line of sight of a user wearing a head mounted display.

### SUMMARY

We thus provide a head mounted display to be mounted on a head of a user when being used. The head mounted display includes: a light source configured to radiate invisible light; a camera configured to image invisible light radiated from the light source and reflected by an eye of a user; an image output unit configured to output an image imaged by the camera to a line-of-sight detecting unit configured to detect a direction of a line of sight of the user; and a housing configured to house the light source, the camera, and the image output unit.

Also, arbitrary combinations of the structural elements described above, and representation of the converted among a method, a device, a system, a computer program, a data structure, a recording medium, and the like are also effective.

### BRIEF DESCRIPTION OF THE DRAWINGS

FIG. 1 is a schematic view illustrating a video system according to an example of our head mounted display.

FIG. 2 is a schematic view illustrating an optical structure of an image display system accommodated in a housing according to the example.

FIG. 3(A) is an illustration of detecting a line of sight with respect to reference positions that are luminous points of invisible light entering an eye of a user.

FIG. 3(B) is another illustration of detecting a line of sight with respect to the reference positions that are the luminous points of invisible light entering the eye of the user.

FIG. 4 is a timing chart schematically illustrating a micromirror control pattern executed by an image control unit according to the example.

FIG. 5(A) is an illustration of an example of luminous points that appear on the eye of the user.

FIG. 5(B) is an illustration of another example of luminous points that appear on the eye of the user.

FIG. 6 is a schematic view illustrating an optical structure of an image display system accommodated in a housing according to a first modified example.

FIG. 7 is a schematic view for illustrating an optical structure of an image display system accommodated in a housing according to a second modified example.

FIG. 8 is a schematic view for illustrating an optical structure of an image display system accommodated in a housing according to a third modified example.

### DETAILED DESCRIPTION

Our head mounted displays will now be described by reference to preferred examples. This does not intend to limit the scope of this disclosure, but to exemplify the head mounted displays.

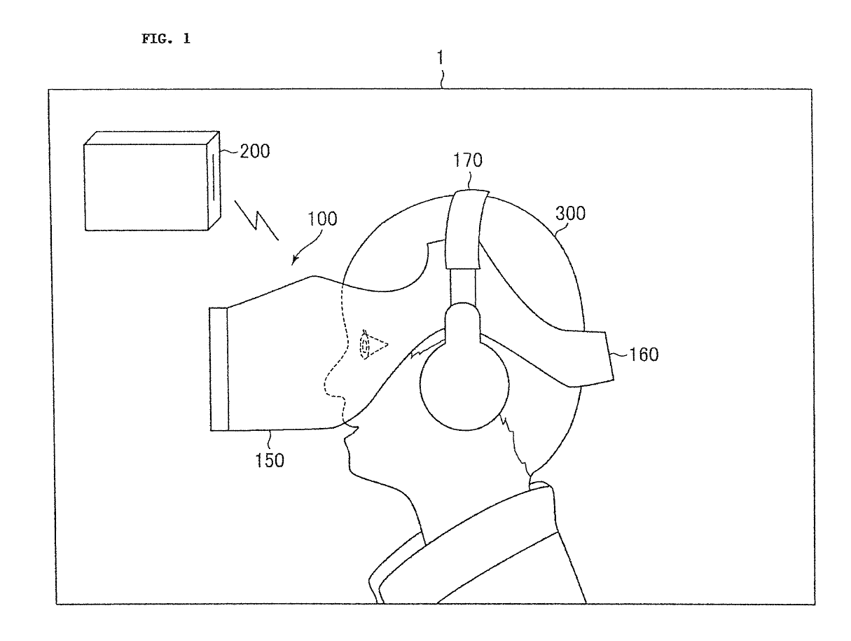

FIG. 1 is a schematic view illustrating a video system 1 according to an example. The video system 1 includes a head mounted display 100 and a video reproducing device 200. As illustrated in FIG. 1, the head mounted display 100 is mounted on a head of a user 300 when being used.

The video reproducing device 200 generates a video to be displayed on the head mounted display 100. The video reproducing device 200 is, for example, but not limited to, a device that can play a video such as a home video game console, a handheld game console, a PC, a tablet, a smartphone, a phablet, a video player, or a television. The video reproducing device 200 connects to the head mounted display 100 via wireless communication or wired communication. As illustrated in FIG. 1, the video reproducing device 200 may connect to the head mounted display 100 via wireless communication. Wireless connection between the video reproducing device 200 and the head mounted display 100 can be realized by, for example, a known wireless communication technology such as WI-FI (trademark) or BLUETOOTH (trademark). Video transmission between the head mounted display 100 and the video reproducing device 200 is realized, for example, but not limited to, in accordance with a standard such as MIRACAST (trademark), WIGIG (trademark), or WHDI (trademark).

FIG. 1 is an illustration of when the head mounted display 100 and the video reproducing device 200 are devices separate from each other. However, the video reproducing device 200 may be built in the head mounted display 100.

The head mounted display 100 includes a housing 150, a mounting member 160, and a headphone 170. The housing 150 accommodates an image display system configured to present a video to the user 300 such as a light source and an image display element to be described later, and a wireless transmission module such as a WI-FI module or a BLUETOOTH module (not shown). The head mounted display 100 is mounted on the head of the user 300 with the use of the mounting member 160. The mounting member 160 can be realized by, for example, a belt or an elastic band. When the user 300 wears the head mounted display 100 using the mounting member 160, the housing 150 is positioned to cover an eye of the user 300. Therefore, when the user 300 wears the head mounted display 100, eyesight of the user 300 is blocked by the housing 150.

The headphone 170 outputs sound of the video reproduced by the video reproducing device 200. It is not necessary to fix the headphone 170 to the head mounted display 100. The user 300 can freely attach or detach the headphone 170 to or from the head mounted display 100 even in a state of wearing the head mounted display 100 using the mounting member 160.

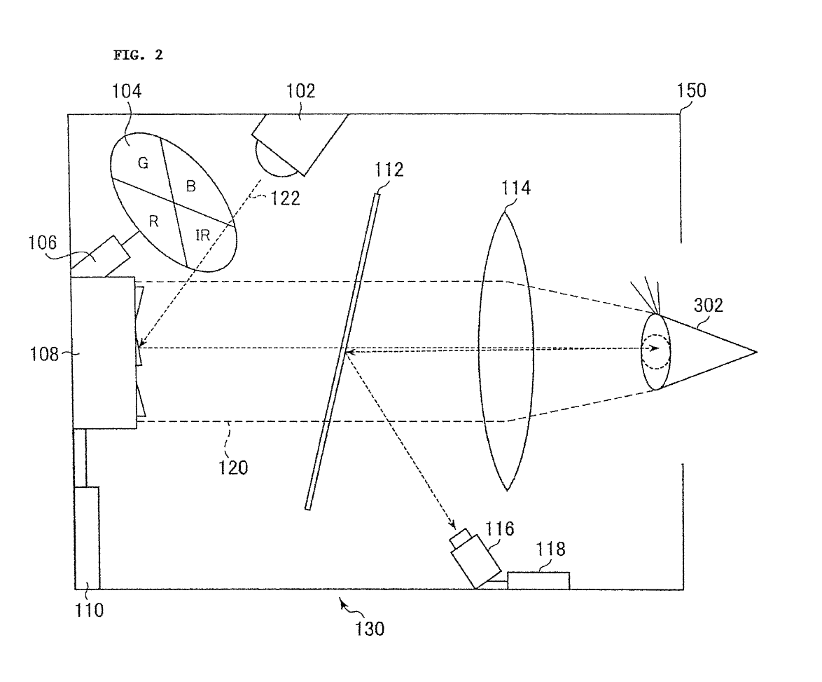

FIG. 2 is a schematic view illustrating an optical structure of an image display system 130 accommodated in the housing 150 according to the example. The image display system 130 includes a white light source 102, a filter group 104, a filter switch unit 106, an image display element 108, an image control unit 110, a half mirror 112, a convex lens 114, a camera 116, and an image output unit 118. In FIG. 2, the white light source 102, the filter group 104, and the filter switch unit 106 form a light source of the image display system 130.

The white light source 102 is a light source that can radiate light including a wavelength band of visible light and a wavelength band of invisible light. Invisible light is light in a wavelength band that cannot be observed with a naked eye of the user 300 and is, for example, light in a near infrared wavelength band (about 800 nm to 2,500 nm).

The filter group 104 includes a red filter R, a green filter G, a blue filter B, and a near infrared filter IR. The red filter R transmits red light in light radiated from the white light source 102. The green filter G transmits green light in light radiated from the white light source 102. The blue filter B transmits blue light in light radiated from the white light source 102. The near infrared filter IR transmits near infrared light in light radiated from the white light source 102.

The filter switch unit 106 switches a filter to transmit light radiated from the white light source 102 among the filters included in the filter group 104. As illustrated in FIG. 2, the filter group 104 is realized using a known color wheel, and the filter switch unit 106 is realized by a motor configured to rotationally drive the color wheel.

More specifically, the color wheel is divided into four regions and, on the regions, the red filter R, the green filter G, the blue filter B, and the near infrared filter IR are respectively arranged, which are described above. The white light source 102 is arranged so that, when the color wheel is in a stopped state, light radiated therefrom may pass through only one specific filter of the filters. Therefore, when the motor as the filter switch unit 106 rotates the color wheel, the filter through which light radiated from the white light source 102 passes is switched cyclically. Therefore, light from the white light source 102 that passes through the color wheel is switched among red light, green light, blue light, and near infrared light in a time division manner. As a result, the light source of the image display system 130 radiates red light, green light, and blue light as visible light and near infrared light as invisible light in a time division manner.

Light that has passed through the filter group 104 enters the image display element 108. Using visible light radiated from the light source, the image display element 108 generates image display light 120. As illustrated in FIG. 2, the image display element 108 is realized using a known digital mirror device (DMD). The DMD is an optical element including a plurality of micromirrors, in which one micromirror corresponds to one pixel of an image.

The image control unit 110 receives a signal of a video to be reproduced from the video reproducing device 200. Based on the received signal of the video, the image control unit 110 separately controls the plurality of micromirrors included in the DMD in synchronization with timing of switching light radiated from the light source.

The image control unit 110 can control each of the micromirrors between an ON state and an OFF state at high speed. When a micromirror is in the ON state, light reflected by the micromirror enters an eye 302 of the user 300. On the other hand, when a micromirror is in the OFF state, light reflected by the micromirror is not directed to the eye 302 of the user 300. By controlling the micromirrors so that light reflected by the micromirrors may form an image, the image control unit 110 forms the image display light 120 based on light reflected by the DMD. Brightness values of the respective pixels can be controlled through control of a time period of the ON state per unit time of the corresponding micromirrors.

When the user 300 wears the head mounted display 100, the half mirror 112 is positioned between the image display element 108 and the eye 302 of the user 300. The half mirror 112 transmits only part of incident near infrared light, and reflects the remaining light. The half mirror 112 transmits incident visible light without reflection. The image display light 120 generated by the image display element 108 passes through the half mirror 112 and travels toward the eye 302 of the user 300.

The convex lens 114 is arranged on an opposite side of the image display element 108 with respect to the half mirror 112. In other words, when the user 300 wears the head mounted display 100, the convex lens 114 is positioned between the half mirror 112 and the eye 302 of the user 300. The convex lens 114 condenses the image display light 120 that passes through the half mirror 112. Therefore, the convex lens 114 functions as an image enlarging unit configured to enlarge an image generated by the image display element 108 and present the enlarged image to the user 300. For the sake of convenience of description, only one convex lens 114 is illustrated in FIG. 2, but the convex lens 114 may be a lens group formed of a combination of various lenses.

Although not illustrated in FIG. 2, the image display system 130 of the head mounted display 100 according to the example includes two image display elements 108, and an image to be presented to a right eye of the user 300 and an image to be presented to a left eye of the user 300 can be separately generated. Therefore, the head mounted display 100 can present a parallax image for the right eye and a parallax image for the left eye to the right eye and the left eye, respectively, of the user 300. This enables the head mounted display 100 to present a three-dimensional video having a depth to the user 300.

As described above, the light source of the image display system 130 radiates red light, green light, and blue light as visible light and near infrared light as invisible light in a time division manner. Therefore, part of near infrared light radiated from the light source and reflected by the micromirrors of the DMD passes through the half mirror 112, and then enters the eye 302 of the user 300. Part of the near infrared light that enters the eye 302 of the user 300 is reflected by the cornea of the eye 302 of the user 300, and reaches the half mirror 112 again.

Part of the near infrared light that is reflected by the eye 302 of the user 300 and reaches the half mirror 112 is reflected by the half mirror 112. The camera 116 includes a filter that blocks visible light, and images the near infrared light reflected by the half mirror 112. In other words, the camera 116 is a near infrared camera configured to image near infrared light that is radiated from the light source of the image display system 130 and is reflected by the cornea of the eye 302 of the user 300.

The image output unit 118 outputs the image imaged by the camera 116 to a line-of-sight detecting unit (not shown) configured to detect a line of sight of the user 300. Specifically, the image output unit 118 sends the image imaged by the camera 116 to the video reproducing device 200. The line-of-sight detecting unit is realized by a line-of-sight detecting program run by a central processing unit (CPU) of the video reproducing device 200. When the head mounted display 100 has a computational resource such as a CPU and a memory, the CPU of the head mounted display 100 may run the program that realizes the line-of-sight detecting unit.

The image imaged by the camera 116 includes a luminous point of near infrared light reflected by the eye 302 of the user 300 and an image of the eye 302 of the user 300 observed in the near infrared wavelength band. The line-of-sight detecting unit can be realized using, for example, but not limited to, a known algorithm to detect a direction of the line of sight of the user 300 from a relative position of a pupil of the user 300 with respect to a reference position that is the luminous point of near infrared light in the image imaged by the camera 116. Radiation of near infrared light in the image display system 130 is described in further detail below.

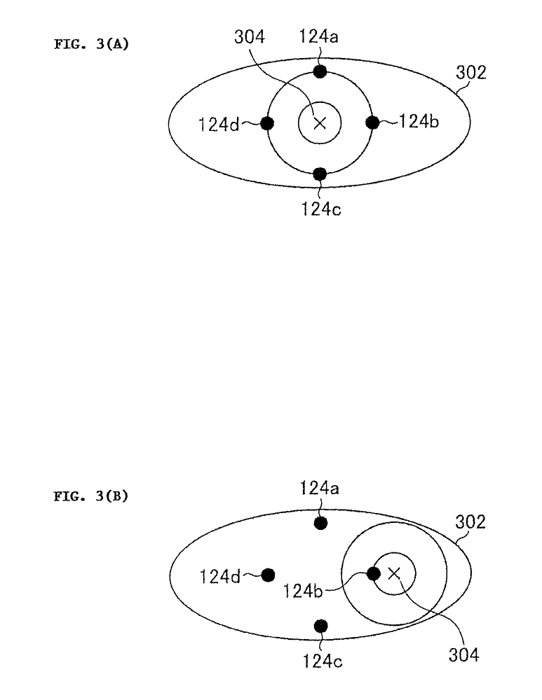

FIGS. 3(A) and 3(B) are illustrations of detecting the line of sight with respect to reference positions that are luminous points of invisible light on the eye 302 of the user 300. More specifically, FIG. 3(A) is an illustration of an image imaged by the camera 116 when the line of sight of the user 300 is directed to the front, while FIG. 3(B) is an illustration of an image imaged by the camera 116 when the line of sight of the user 300 is sideways.

In each of FIGS. 3(A) and 3(B), a first luminous point 124a, a second luminous point 124b, a third luminous point 124c, and a fourth luminous point 124d appear on the eye 302 of the user 300. Each of the first luminous point 124a, the second luminous point 124b, the third luminous point 124c, and the fourth luminous point 124d is a luminous point caused by near infrared light radiated from the light source and reflected by the cornea of the eye 302 of the user 300. The first luminous point 124a, the second luminous point 124b, the third luminous point 124c, and the fourth luminous point 124d are hereinafter simply and collectively referred to as “luminous points 124” when discrimination thereamong is unnecessary.

With reference to FIG. 3(A), the first luminous point 124a, the second luminous point 124b, the third luminous point 124c, and the fourth luminous point 124d are caused by reflection by the cornea on a boundary of an iris of the eye 302 when the line of sight of the user 300 is directed to the front. Radiation is performed so that the luminous points 124 are caused at the same positions insofar as the housing 150 is fixed to the head of the user 300 and a relative position between the eye 302 of the user 300 and the image display element 108 remains the same. Therefore, the luminous points 124 can be regarded as fixed points or landmarks on the eye 302 of the user 300. When the line of sight of the user 300 is directed to the front as illustrated in FIG. 3(A), a center 304 of the pupil of the user 300 completely overlaps a center of the first luminous point 124a, the second luminous point 124b, the third luminous point 124c, and the fourth luminous point 124d.

When, as illustrated in FIG. 3(B), the line of sight of the user 300 moves sideways, the center 304 of the pupil of the user 300 also moves together therewith. On the other hand, the positions of the luminous points 124 on the eye 302 of the user 300 do not change. Therefore, the line-of-sight detecting unit can obtain a position of the center 304 of the pupil with respect to the luminous points 124 by analyzing the image obtained from the camera 116. This enables the line-of-sight detecting unit to detect the direction of the line of sight of the user 300. Detection of the luminous points 124 and the center 304 of the pupil in the image obtained from the camera 116 can be realized by using a known image processing technology such as edge extraction or Hough transform.

In each of FIGS. 3(A) and 3(B), the four luminous points 124 caused by near infrared light reflected by the cornea appear on the eye 302 of the user 300. However, the number of the luminous points 124 is not limited to four, and is only required to be at least one. As the number of the luminous points 124 becomes larger, robustness of detection of the direction of the line of sight of the user 300 is more improved. The reason is that, even when near infrared light entering the eye 302 of the user 300 from a certain position in the image display element 108 is blocked by some obstacle such as an eyelid or an eyelash of the user 300 and cannot enter the eye 302, near infrared light entering the eye 302 from another position may reach the eye 302 of the user 300.

For the luminous points 124 caused by near infrared light reflected by the cornea to appear on the eye 302 of the user 300, the image control unit 110 controls the plurality of micromirrors of the DMD so that, when the light source radiates near infrared light, near infrared light for at least one pixel may enter the eye 302 of the user 300.

FIGS. 3(A) and 3(B) are illustrations of when the luminous points 124 are circular. With reference to FIG. 3(B), the first luminous point 124a, the third luminous point 124c, and the fourth luminous point 124d are away from the iris. In reality, a luminous point 124 that is away from the iris may have a distorted shape. However, to not make the content of the technology be unclear by unnecessarily detailed description, in FIG. 3(B), the luminous points 124 are illustrated as circular.

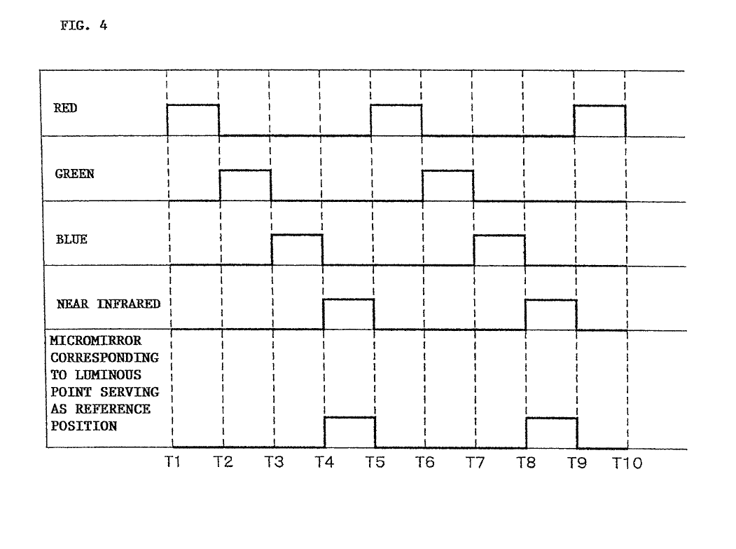

FIG. 4 is a timing chart schematically illustrating a micromirror control pattern executed by the image control unit 110 according to the example. As described above, the filter switch unit 106 switches the red filter R, the green filter G, the blue filter B, and the near infrared filter IR cyclically. Therefore, as illustrated in FIG. 4, light that enters the DMD as the image display element 108 is also switched cyclically among red light, green light, blue light, and near infrared light.

As illustrated in FIG. 4, during a period from a time T1 to a time T2, red light enters the image display element 108. During a period from the time T2 to a time T3, green light enters the image display element 108. Similarly, during a period from the time T3 to a time T4, blue light enters the image display element 108 and, during a period from the time T4 to a time T5, near infrared light enters the image display element 108. This is repeated. Red light, green light, blue light, and near infrared light enter the image display element 108 cyclically in a time division manner in a cycle of a period D from the time T1 to the time T5.

As illustrated in FIG. 4, the image control unit 110 sets, in synchronization with timing of entrance of near infrared light to the image display element 108, micromirrors corresponding to the luminous points 124 serving as the reference points in detecting the line of sight to be in the ON state. As illustrated in FIG. 4, during the period from the time T4 to the time T5 in which near infrared light enters the image display element 108, the micromirrors corresponding to the luminous points 124 are set in the ON state. This can be realized by, for example, obtaining a drive signal for the filter switch unit 106 by the image control unit 110.

The “micromirrors corresponding to the luminous points 124” as used herein mean, for example, micromirrors corresponding to the first luminous point 124a, the second luminous point 124b, the third luminous point 124c, and the fourth luminous point 124d illustrated in FIGS. 3(A) and 3(B). Which of the plurality of micromirrors included in the DMD are set to be the micromirrors corresponding to the luminous points 124 may be determined by, for example, performing calibration for defining the luminous points 124 before the user 300 uses the head mounted display 100.

The micromirrors corresponding to the luminous points 124 are also used in forming the image display light. Therefore, during the period from the time T1 to the time T4 in which visible light enters the image display element 108, the image control unit 110 controls ON/OFF of the micromirrors corresponding to the luminous points 124 based on a video signal. This enables the image control unit 110 to generate the image display light based on a video signal to the user 300 when visible light enters the image display element 108, and to form the luminous points 124 on the eye 302 of the user 300 when near infrared light enters the image display element 108.

Further, when the user 300 wears the head mounted display 100, the image display element 108 is positioned at a position directly facing the eye 302 of the user 300. Therefore, the head mounted display 100 can radiate near infrared light to form the luminous points 124 from the front of the eye 302 of the user 300. This can inhibit near infrared light to enter the eye 302 of the user 300 from being blocked by, for example, an eyelash or an eyelid of the user 300. As a result, the robustness of detection of the line of sight of the user 300 executed by the line-of-sight detecting unit can be improved.

Meanwhile, as described above with reference to FIGS. 3(A) and 3(B), the image control unit 110 controls the respective micromirrors of the DMD so that the four luminous points 124 caused by near infrared light reflected by the cornea may appear on the eye 302 of the user 300. Therefore, it is convenient if the plurality of luminous points 124 can be each identified on the image imaged by the camera 116, the detection of the line of sight by the line-of-sight detecting unit is facilitated. The reason is that which of the luminous points 124 appears on the eye 302 of the user 300 is more easily discriminated.

Therefore, the image control unit 110 may control the micromirrors respectively corresponding to the plurality of luminous points 124 to be cyclically and sequentially turned ON. Alternatively, the image control unit 110 may control the micromirrors respectively corresponding to the plurality of luminous points 124 so that the plurality of luminous points 124 that appear on the eye 302 of the user 300 may have shapes different from one another.

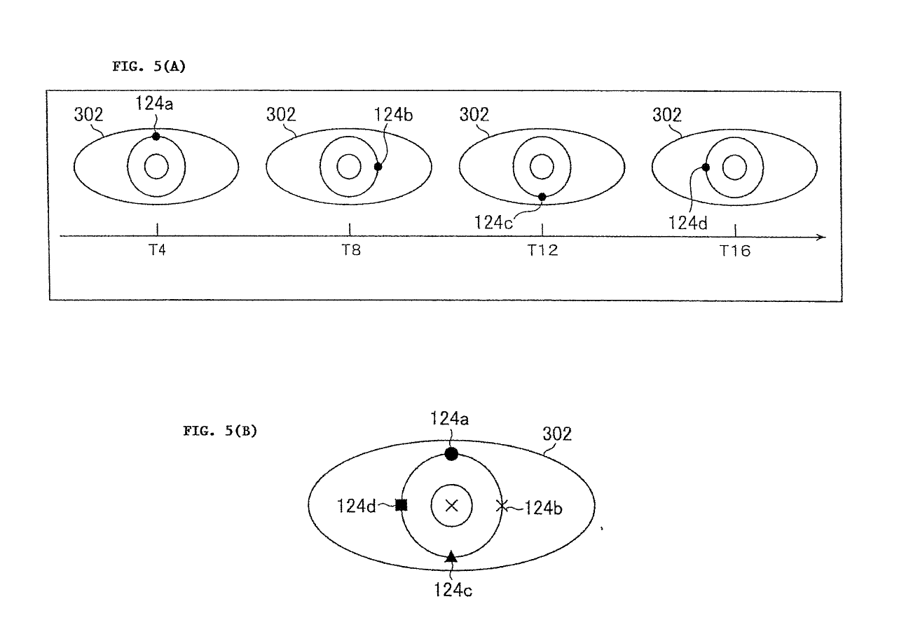

FIGS. 5(A) and 5(B) are illustrations of exemplary sets of the luminous points 124 that appear on the eye 302 of the user 300. More specifically, FIG. 5(A) is an illustration of when the plurality of luminous points 124 appear on the eye 302 of the user 300 sequentially in a time division manner. FIG. 5(B) is an illustration of when the plurality of luminous points 124 have shapes different from one another. FIG. 5(A) corresponds to when identifiers for uniquely identifying the plurality of luminous points 124 are set using so-called temporal variations. FIG. 5(B) corresponds to when the identifiers for uniquely identifying the plurality of luminous points 124 are set using so-called spatial variations.

In the case illustrated in FIG. 5(A), when the image control unit 110 sets the micromirror corresponding to, for example, the first luminous point 124a to be in the ON state, the image control unit 110 sets the micromirrors corresponding to the second luminous point 124b, the third luminous point 124c, and the fourth luminous point 124d to be in the OFF state even at timing at which near infrared light enters the image display element 108. As illustrated in FIGS. 3(A) and 3(B), near infrared light cyclically enters the image display element 108, and entrance start times thereof are T4, T8, T12, T16, and so on, at intervals of the period D described above.

At the time T4, the image control unit 110 controls the micromirror corresponding to the first luminous point 124a so that the first luminous point 124a may appear on the eye 302 of the user 300. At the time T8, the image control unit 110 controls the micromirror corresponding to the second luminous point 124b so that the second luminous point 124b may appear on the eye 302 of the user 300. This is repeated and, at the time T12 and at the time T16, the image control unit 110 controls the micromirrors so that the third luminous point 124c and the fourth luminous point 124d may appear on the eye 302 of the user 300. This enables the line-of-sight detecting unit to uniquely identify each of the plurality of luminous points 124 using timing of appearance thereof.

As illustrated in FIG. 5(B), differently from FIG. 5(A), the first luminous point 124a, the second luminous point 124b, the third luminous point 124c, and the fourth luminous point 124d simultaneously appear on the eye 302 of the user 300. However, the first luminous point 124a, the second luminous point 124b, the third luminous point 124c, and the fourth luminous point 124d have shapes different from one another. As illustrated in FIG. 5(B), the first luminous point 124a is in the shape of a circle, the second luminous point 124b is in the shape of X, the third luminous point 124c is in the shape of a triangle, and the fourth luminous point 124d is in the shape of a quadrangle. The image control unit 110 controls the micromirrors so that these shapes may appear on the eye 302 of the user 300. In this case, to form the shapes of the luminous points 124, not one micromirror but a plurality of micromirrors correspond to each of the luminous points 124.

The shapes of the luminous points 124 are only exemplary, and the luminous points 124 may have any shape insofar as the shapes are different from one another. This enables the line-of-sight detecting unit to uniquely identify the plurality of luminous points 124 using the respective shapes thereof. Compared to when the luminous points 124 are identified using timing of the appearance thereof, this is advantageous in that a specific temporal resolution of the luminous points 124 can be enhanced.

As described above, in the head mounted display 100, by causing light radiated from the white light source 102 to pass through the filters included in the filter group 104, visible light and invisible light are radiated cyclically in a time division manner. Thus, in a cycle of radiation of light in a time division manner, a period during which visible light from the light source of the image display system 130 passes affects brightness of a video presented to the user 300. Specifically, as a period during which visible light from the light source of the image display system 130 passes in the cycle of radiation of light in a time division manner becomes longer, a video presented to the user 300 becomes brighter.

On the other hand, as a period during which visible light from the light source of the image display system 130 passes in the cycle of radiation of light in a time division manner becomes shorter, that is, as a period during which invisible light passes becomes longer, the luminous points 124 in the image imaged by the camera 116 become more obvious. As illustrated in FIG. 2, the period during which visible light from the light source of the image display system 130 passes in the cycle of radiation of light in a time division manner depends on areas of the filters that transmit visible light in the color wheel realizing the filter group 104. Specifically, the filters that transmit visible light are the red filter R, the green filter G, and the blue filter B among the filters included in the filter group 104. The filter that transmits invisible light is the near infrared filter IR among the filters included in the filter group 104.

In this case, in the filter group 104, an area of the near infrared filter IR may be different from the areas of the remaining filters. For example, by setting the area of the near infrared filter IR to be smaller than the areas of the remaining filters, a bright video can be presented to the user 300. On the other hand, by setting the area of the near infrared filter IR to be larger than the areas of the remaining filters, the luminous points 124 can be made more obvious. As a result, the robustness of detection of the line of sight of the user 300 can be improved.

Operation of the video system 1 having the structure described above is as follows. First, the user 300 wears the head mounted display 100 using the mounting member 160 so that the housing 150 of the head mounted display 100 may be positioned in front of the eye 302 of the user 300. Then, the user 300 performs calibration to define the luminous points 124 so that the luminous points 124 may appear on the iris or on the boundary of the iris of the eye 302.

The image control unit 110 turns on the micromirrors corresponding to the luminous points 124 in synchronization with timing of radiation of near infrared light from the light source of the image display system 130. The camera 116 obtains a near infrared image of the eye 302 of the user 300 including near infrared light reflected by the cornea on the eye 302 of the user 300. In the image obtained by the camera 116, luminous points caused by the near infrared light reflected by the cornea on the eye 302 of the user 300 are the luminous points 124 described above. The image output unit 118 outputs the image obtained by the camera 116 to the video reproducing device 200. The line-of-sight detecting unit in the video reproducing device 200 detects the direction of the line of sight of the user 300 through analysis of the image obtained by the camera 116.

The direction of the line of sight of the user 300 detected by the line-of-sight detecting unit is sent to, for example, an operating system configured to control functions of the video reproducing device 200 in a centralized manner and is used for an input interface to operate the head mounted display 100 or the like.

As described above, the head mounted display 100 according to the example can detect the direction of the line of sight of the user 300 wearing the head mounted display 100.

In particular, in the head mounted display 100, near infrared light can enter from the front of the eye 302 of the user 300 wearing the head mounted display 100. This enables near infrared light to enter the eye 302 of the user 300 with stability. Therefore, stability of detecting the line of sight of the user 300 with respect to the luminous points 124 caused by near infrared light reflected by the cornea of the eye of the user 300 can be improved.

Further, in the head mounted display 100, the light source configured to radiate invisible light such as near infrared light is built in the housing 150 of the head mounted display 100. Therefore, although the housing 150 of the head mounted display 100 covers the eye 302 of the user 300, invisible light can be radiated to the eye 302 of the user 300.

One example of our head mounted displays is described above. That construction is only exemplary, and those skilled in the art will recognize that various modified examples of a combination of structural elements and of the processes are possible and that such modified examples are also within the scope of this disclosure.

### First Modified Example

When the light source of the image display system 130 is the white light source 102 is described above. Instead, the light source of the image display system 130 may be an aggregation of a plurality of light sources of different wavelengths.

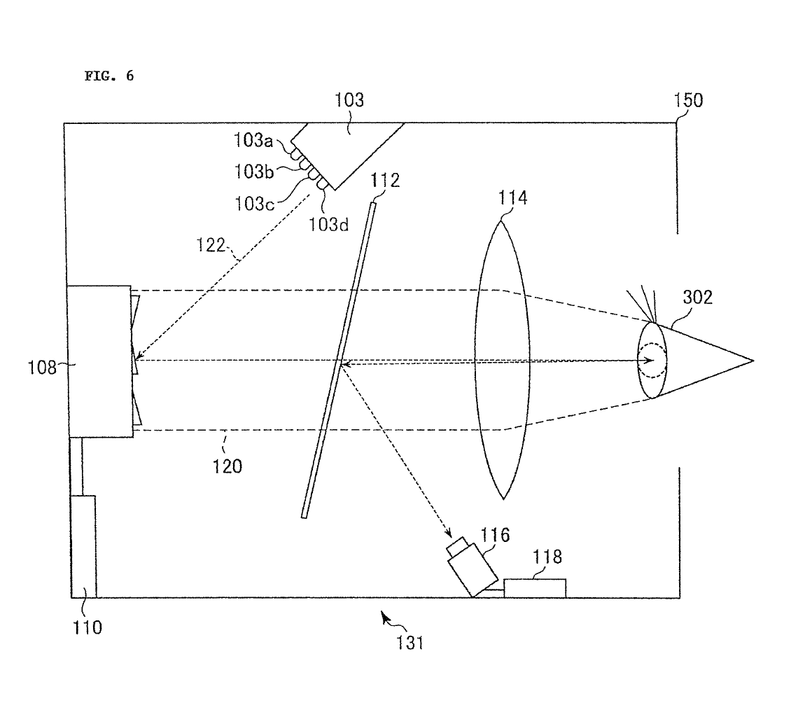

FIG. 6 is a schematic view illustrating an optical structure of an image display system 131 accommodated in the housing 150 according to a first modified example. Where description of the image display system 131 hereinafter overlaps that of the image display system 130, the description is omitted or is made only in brief as appropriate.

The image display system 131 according to the first modified example includes, similarly to the image display system 130, the image display element 108, the image control unit 110, the half mirror 112, the convex lens 114, the camera 116, and the image output unit 118. On the other hand, the image display system 131 according to the first modified example does not include, differently from the image display system 130 according to the example, the white light source 102, the filter group 104, and the filter switch unit 106. Instead, the image display system 131 according to the first modified example includes a light source group 103.

The light source group 103 is an aggregation of a plurality of light sources of different wavelengths. More specifically, the light source group 103 includes a red light source 103a, a green light source 103b, a blue light source 103c, and a near infrared light source 103d. The red light source 103a, the green light source 103b, the blue light source 103c, and the near infrared light source 103d can be realized using, for example, LED light sources. Specifically, the red light source 103a can be realized using a red LED for radiating red light, the green light source 103b can be realized using a green LED for radiating green light, the blue light source 103c can be realized using a blue LED for radiating blue light, and the near infrared light source 103d can be realized using an infrared LED for radiating near infrared light.

As described above, the light source group 103 can separately radiate light of the different wavelengths and, thus, the filter group 104 and the filter switch unit 106 are not necessary. It is enough that the light source group 103 causes the LEDs to emit light in accordance with the timing chart as illustrated in FIG. 4. Similar to the video system 1 according to the example, the period during which visible light is radiated from the light source group 103 and the period during which invisible light is radiated from the light source group 103 may be different from each other in the cycle of radiation of light in a time division manner.

A head mounted display 100 including the image display system 131 according to the first modified example has an effect similar to that of the head mounted display 100 including the image display system 130 according to the example described above. In addition, compared to the image display system 130 according to the example, the image display system 131 according to the first modified example does not include the filter switch unit 106 that is realized by a motor or the like and, thus, factors of failure are reduced and, further, the low noise, low vibration, and lightweight head mounted display 100 can be realized.

### Second Modified Example

Examples in which the half mirror 112 is used for imaging invisible light reflected by the eye 302 of the user 300 are described above. However, the half mirror 112 is not indispensable, and may be omitted.

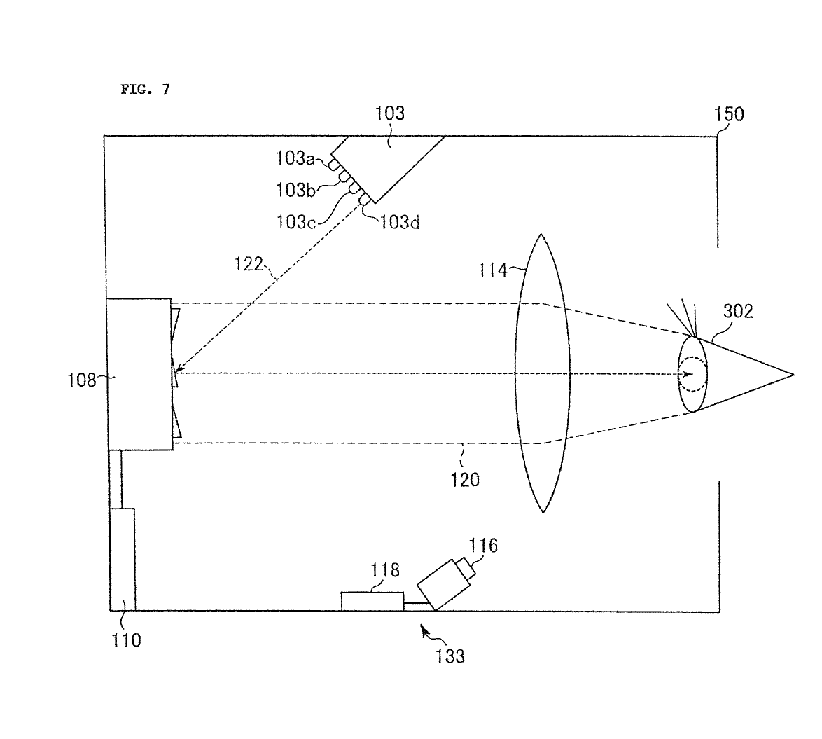

FIG. 7 is a schematic view illustrating an optical structure of an image display system 132 accommodated in the housing 150 according to a second modified example. Where description of the image display system 132 hereinafter overlaps the above description of the image display system 130 or the image display system 131, the description is omitted or is made only in brief as appropriate.

The image display system 132 according to the second modified example includes, in the housing 150 thereof, the light source group 103, the image display element 108, the image control unit 110, the convex lens 114, the camera 116, and the image output unit 118.

Timing of radiation by the red light source 103a, the green light source 103b, the blue light source 103c, and the near infrared light source 103d included in the light source group 103 is similar to that in the timing chart illustrated in FIG. 4.

In the image display system 130 according to the example and in the image display system 131 according to the first modified example, the camera 116 images the luminous points 124 that appear on the eye 302 of the user 300 after the luminous points 124 are reflected by the half mirror 112. On the other hand, in the image display system 132 according to the second modified example, the camera 116 is directed toward the eye 302 of the user 300, and directly images near infrared light reflected by the eye 302 of the user 300.

The head mounted display 100 including the image display system 132 according to the second modified example has an effect similar to that of the head mounted display 100 including the image display system 130 according to the example described above. In addition, the camera 116 can image the luminous points 124 caused by near infrared light without using the half mirror 112. It is not necessary to accommodate the half mirror 112 in the housing 150 and, thus, the head mounted display 100 can be reduced in weight and downsized. Further, contribution to cost reduction of the head mounted display 100 is expected. Still further, the number of components in an optical circuit forming the image display system is reduced, and thus, problems such as misalignment of an optical axis can be reduced.

### Third Modified Example

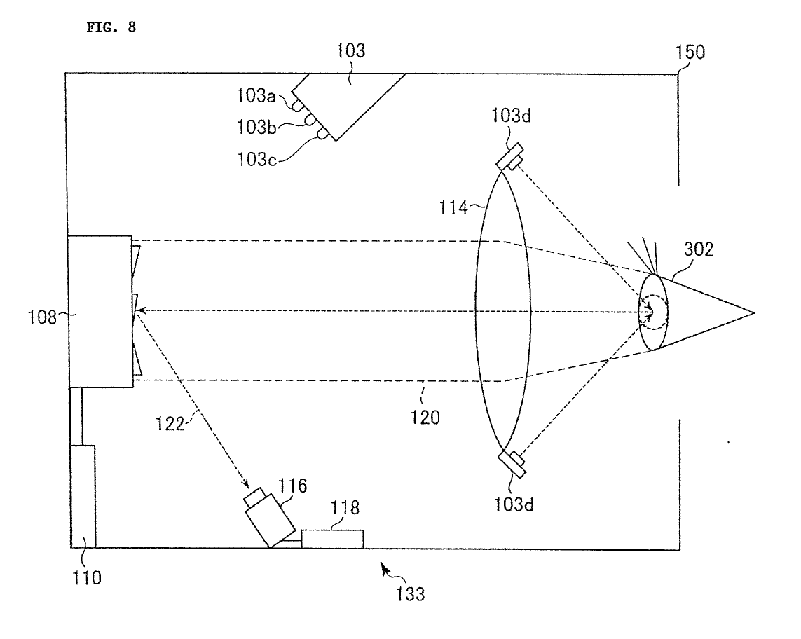

FIG. 8 is a schematic view illustrating an optical structure of an image display system 133 accommodated in the housing 150 according to a third modified example. Where description of the image display system 133 hereinafter overlaps the above description of the image display system 130, the image display system 131, or the image display system 132, the description is omitted or is made only in brief as appropriate.

The image display system 133 according to the third modified example includes the light source group 103, the near infrared light source 103d, the image display element 108, the image control unit 110, the convex lens 114, the camera 116, and the image output unit 118. The light source group 103 included in the image display system 133 according to the third modified example includes the red light source 103a, the green light source 103b, and the blue light source 103c, but does not include the near infrared light source 103d. As illustrated in FIG. 8, in the image display system 133 according to the third modified example, the near infrared light source 103d is arranged in proximity to a side surface of the convex lens 114.

More specifically, the near infrared light source 103d is arranged to be able to radiate near infrared light toward the eye 302 of the user 300. FIG. 8 is an illustration in which two near infrared light sources 103d are arranged at a top and at a bottom, respectively, of the convex lens 114. However, the number of the near infrared light sources 103d is not limited to two, and it is enough that the number is at least one. When there are a plurality of near infrared light sources 103d, as illustrated in FIG. 3(A), near infrared light is radiated toward different positions on the eye 302 of the user 300 to cause the luminous points 124 at the different positions.

Timing of radiation by the red light source 103a, the green light source 103b, and the blue light source 103c included in the light source group 103, and timing of radiation by the near infrared light sources 103d are similar to those in the timing chart illustrated in FIG. 4. In the timing chart illustrated in FIG. 4, for example, during the period from the time T4 to the time T5, the plurality of near infrared light sources 103d simultaneously emit light. In the image display system 133 according to the third modified example, the micromirrors are controlled so that near infrared light reflected by the eye 302 of the user 300 may be radiated to the camera 116 at timing of “micromirror corresponding to luminous point serving as reference position” in the timing chart illustrated in FIG. 4.

More particularly, in the image display system 133 according to the third modified example, as illustrated in FIG. 8, the micromirrors of the DMD are used for the purpose of changing optical paths of near infrared light radiated from the near infrared light sources 103d and is reflected by the eye 302 of the user 300 to be toward the camera 116. To realize this, the image control unit 110 controls the micromirrors of the DMD so that near infrared light reflected by the eye 302 of the user 300 when the near infrared light sources 103d radiate near infrared light may travel toward the camera 116. This enables the camera 116 to image the luminous points 124 caused by near infrared light without using the half mirror 112. It is not necessary to accommodate the half mirror 112 in the housing 150 and, thus, the head mounted display 100 can be reduced in weight and downsized. Further, contribution to cost reduction of the head mounted display 100 is expected. Still further, the number of components in an optical circuit forming the image display system is reduced and, thus, problems such as misalignment of an optical axis can be reduced.

### Fourth Modified Example

With regard to the image display system 130 according to the example and the image display system 131 according to the first modified example described above, when the image display element 108 is realized as a DMD are described. However, the image display element 108 is not limited to a DMD and other reflection type devices may also be used. For example, the image display element 108 may be realized as Liquid Crystal On Silicon (LCOS) (trademark) instead of a DMD.

### Fifth Modified Example

In the above description with reference to FIGS. 5(A) and 5(B), when temporal variations or spatial variations of the respective plurality of luminous points 124 are set to identify the respective luminous points 124 are described. Other than this, as another example of temporal variations, the luminous points 124 may be identified using frequency variations. For example, the near infrared light source 103d controls a frequency of lighting of near infrared light so that the first luminous point 124a, the second luminous point 124b, the third luminous point 124c, and the fourth luminous point 124d in the case illustrated in FIGS. 5(A) and 5(B) may blink. The frequency of the blinks is set to be different among the luminous points 124. The line-of-sight detecting unit can identify the respective luminous points 124 through analysis of the frequencies of the luminous points appearing in moving images imaged by the camera 116. Alternatively, the line-of-sight detecting unit may identify the respective luminous points through acquisition of ON/OFF ratios of lighting in PWM control of the near infrared light source 103d.

The video system 1 is described above based on the example and the modified examples. Other modified examples which arbitrarily combine structures in the example or the modified examples are also regarded as modified examples.

For example, the positions of the near infrared light sources 103d in the image display system 133 according to the third modified example may be changed to the position of the near infrared light source 103d in the image display system 132 according to the second modified example. Specifically, in the image display system 133 according to the third modified example, the convex lens may have a reflection region, and the near infrared light source 103d may be arranged so that near infrared light may enter the reflection region.

1-7. (canceled)

8. A head mounted display to be mounted on a head of a user when being used, comprising:
a light source configured to radiate visible light and near infrared light;
a camera configured to image near infrared light radiated from the light source and reflected by an eye of the user;
an image output unit configured to output an image imaged by the camera to a line-of-sight detecting unit configured to detect a direction of a line of sight of the user;
an image display element configured to generate image display light by using visible light radiated from the light source; and
a housing configured to accommodate the light source, the camera, the image display element, and the image output unit,
the light source comprising:
a white light source configured to radiate light including light in a near infrared wavelength region;
a filter group comprising a red filter configured to transmit red light, a blue filter configured to transmit blue light, a green filter configured to transmit green light, and a near infrared filter configured to transmit near infrared light, among the light radiated from the white light source; and
a filter switch unit configured to switch among the filters in the filter group,
the camera being configured to image near infrared light radiated from the light source and reflected by the eye of the user via the image display element,
the near infrared filter in the filter group having an area that is different from areas of the remaining filters.

9. The head mounted display according to claim 8, further comprising a half mirror configured to reflect invisible light, the half mirror being positioned between the image display element and the eye of the user when the user wears the head mounted display,
wherein the camera images the invisible light reflected by the eye of the user and by the half mirror.

10. The head mounted display according to claim 8, wherein the light source radiates visible light and near infrared light in a time division manner.

11. The head mounted display according to claim 8,
wherein the image display element comprises a digital mirror device (DMD) comprising a plurality of micromirrors each corresponding to one pixel,
the head mounted display further comprises an image control unit configured to separately control the plurality of micromirrors, and
the image control unit controls the plurality of micromirrors so that near infrared light for at least one pixel enters the eye of the user when the light source radiates near infrared light.

12. A head mounted display to be mounted on a head of a user when being used, comprising:
a light source that radiates visible light and near infrared light;
a camera that images near infrared light radiated from the light source and reflected by an eye of the user;
an image output that outputs an image imaged by the camera to a line-of-sight detector that detects a direction of a line of sight of the user;
an image display element that generates image display light by using visible light radiated from the light source; and
a housing sized and shaped to accommodate the light source, the camera, the image display element, and the image output unit,
the light source comprising:
a white light source that radiates light including light in a near infrared wavelength region;
a filter group comprising a red filter that transmits red light, a blue filter that transmits blue light, a green filter that transmits green light, and a near infrared filter that transmits near infrared light, among the light radiated from the white light source; and
a filter switch that switches among the filters in the filter group,
the camera imaging near infrared light radiated from the light source and reflected by the eye of the user via the image display element, and
the near infrared filter in the filter group having an area different from areas of remaining filters.
